(19) United States
(12) Patent Application Publication
(10) Pub. No.: US 2009/0067315 A1
(43) Pub. Date: Mar. 12, 2009

(54) MULTI-CHANNEL OPTICAL RECORDING AND/OR REPRODUCING APPARATUS AND METHOD OF CONTROLLING THE SAME

(75) Inventors: Kyongtae PARK, Suwon-si (KR); Tae-kyung Kim, Seoul (KR); Jae-cheol Bae, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/037,365

(22) Filed: Feb. 26, 2008

(30) Foreign Application Priority Data
Sep. 12, 2007 (KR) 2007-92818

(51) Int. Cl. G11B 7/14; G11B 7/00

(52) U.S. Cl. 369/124.02; 369/124.03

(57) ABSTRACT

A multi-channel optical recording and/or reproducing apparatus includes an optical pickup including a plurality of light sources, the optical pickup being adapted to emit a plurality of light beams to a corresponding plurality of tracks of an information storage medium and to detect a plurality of light beams reflected by the corresponding plurality of tracks of the information storage medium; and a control signal generating unit to generate a control signal which equalizes and controls aberrations occurring due to a wavelength difference between the plurality of light sources, a displacement difference on an optical axis between the light sources, or a distance between the light sources, based on detection signals generated according to the plurality of reflected light beams.

### CROSS-REFERENCE TO RELATED APPLICATION

This application claims the benefit of Korean Application No. 2007-92818, filed Sep. 12, 2007 in the Korean Intellectual Property Office, the disclosure of which is incorporated herein by reference.

### BACKGROUND OF THE INVENTION

1. Field of the Invention

Aspects of the present invention relate to a multi-channel optical recording and/or reproducing apparatus, and more particularly, to a multi-channel optical recording and/or reproducing apparatus and a method of controlling the same, which simultaneously records signals in different tracks of an optical disc and/or simultaneously reproduces signals in different tracks of an optical disc using light beams emitted by a plurality of light sources to increase a data transfer rate (DTR).

2. Description of the Related Art

In optical data storage, the number of recording layers manufactured in blu-ray discs (BDs), HD-DVDs, DVDs, and other types of optical discs has been increased to increase storage capacity. Accordingly, a demand for a higher data transfer rate (DTR) has also grown. One attempt to increase the DTR is the introduction of a multi-channel pickup which can simultaneously reproduce signals in a plurality of tracks and simultaneously record data on the tracks using a plurality of light sources.

The plurality of light sources may be emitted by a laser diode (LD) array or by an assembly of a plurality of LDs. In these cases, however, the light beams focused by an objective lens on a disc may have differing wavefront aberrations due to a wavelength difference between the light beams emitted from the light sources, a displacement difference on an optical axis between the light sources, or a distance between the light sources. The differences in the wavefront aberrations result in a great dispersion of recording and reproducing performances using the multi-channel pickup signals.

Accordingly, in order to realize a multi-channel with a high DTR, it is necessary to reduce a difference in performance between channels of a multi-channel optical pickup resulting from wavefront aberrations.

### SUMMARY OF THE INVENTION

Aspects of the present invention provide a multi-channel optical recording and/or reproducing apparatus and a method of controlling the same, which reduces a difference in recording and/or reproducing performance between channels of a multi-channel optical pickup resulting from light spots having different wavefront aberrations and increases an optical axis adjustment tolerance by equalizing aberrations produced due to a displacement difference on an optical axis between light sources, a wavelength difference between the light sources, or a distance between the light sources.

According to an aspect of the present invention, a multi-channel optical recording and/or reproducing apparatus includes an optical pickup including a plurality of light sources, the optical pickup being adapted to emit a plurality of light beams to a corresponding plurality of tracks of an information storage medium and to detect the plurality of light beams reflected by the corresponding plurality of tracks of the information storage medium, and a control signal generating unit to generate a control signal which equalizes and controls aberrations produced due to a wavelength difference between the plurality of light sources, a displacement difference on an optical axis between the light sources, or a distance between the light sources, based on detection signals generated according to the plurality of reflected light beams.

According to an aspect, the control signal generating unit includes a focus error signal detecting unit to detect a plurality of focus error signals corresponding to the plurality of reflected light beams; and an objective lens driver control signal generator to generate the control signal which applies a defocus corresponding to an average of the focus error signals to a focus servo signal.

According to an aspect, the control signal generating unit includes a focus error signal detecting unit to detect a plurality of focus error signals corresponding to the plurality of reflected light beams; and an objective lens driver control signal generator to generate a control signal to set a light beam, in which a focus error signal is generated first among the plurality of light beams, as a reference light beam and to apply a defocus corresponding to an average of a zero crossing point of a focus error signal corresponding to the reference light beam and a point corresponding to the zero crossing point for a focus error signal having a highest level difference in relation to the focus error signal which is generated first among the focus error signals of the other focus error signals to a focus servo signal.

According to an aspect, the optical pickup further includes an objective lens to focus the plurality of light beams on the information storage medium; and a driver to drive the objective lens, wherein a focusing operation is controlled using the control signal generated by the objective lens driver control signal generator.

According to an aspect, the control signal generating unit further includes a comparing/judging unit to compare the plurality of focus error signals and to judge which focus error signal is generated first.

According to an aspect, the optical pickup further includes a spherical aberration compensating unit including a compensating lens to compensate for a spherical aberration and a second driver to drive the compensating lens, the control signal generating unit further includes a sum signal detecting unit to detect a plurality of sum signals corresponding to the plurality of reflected light beams, and a spherical aberration compensating driver control signal generator to generate a second control signal which adjusts a position of the compensating lens of the first spherical aberration compensating unit, and the comparing/judging unit inputs a sum signal for a reference light beam, in which a focus error signal is generated first, among the plurality of sum signals to the spherical aberration compensating driver control signal generator to generate the second control signal.

According to an aspect, the position of the compensating lens is adjusted so that a level of the sum signal detected with respect to the reference light beam is maximized.

According to an aspect, the optical pickup further includes a spherical aberration compensating unit including a compensating lens to compensate for a spherical aberration and a driver to drive the compensating lens, the control signal generating unit further includes a sum signal detecting unit to detect a plurality of sum signals corresponding to the plurality of reflected light beams, and a spherical aberration compensating driver control signal generator to generate a second control signal which adjusts a position of the compensating lens of the spherical aberration compensating unit, wherein the comparing/judging unit inputs a sum signal for a reference light beam, in which a focus error signal is generated first, among the plurality of sum signals to the spherical aberration compensating driver control signal generator to generate the second control signal.

According to an aspect, the plurality of light sources includes a first light source and a second light source to respectively emit a first light beam and a second light beam, and the optical pickup further includes an optical path coupler to couple optical paths of the first and second light beams respectively emitted by the first and second light sources; and a second spherical aberration compensating unit disposed on the optical path of the first or second light beam at a position before a position where the optical paths of the first and second light beams respectively emitted by the first and second light beams are coupled to each other.

According to an aspect, the plurality of light sources includes a first light source and a second light source to respectively emit a first light beam and a second light beam which have orthogonal polarizations to each other, and the optical pickup further includes a polarizing beam splitter to couple optical paths of the first and second light beams respectively emitted by the first and second light sources.

According to an aspect, the optical pickup further includes a second spherical aberration compensating unit disposed at a position on an optical path after a position where the optical paths of the first and second light beams respectively emitted by the first and second light sources are coupled to each other, wherein the second spherical aberration compensating unit includes a liquid crystal lens to act as a polarizing element; and a power source to drive the liquid crystal lens to match focus error signals based on the plurality of reflected light beams.

According to another aspect of the present invention, a method of controlling a multi-channel optical recording and/or reproducing apparatus includes emitting a plurality of light beams from a plurality of light sources to a plurality of tracks of an information storage medium, detecting the plurality of light beams reflected by the tracks of the information storage medium, generating a control signal to equalize and control aberrations produced due to a wavelength difference between the light sources or a displacement difference on an optical axis between the light sources based on detection signals generated according to the plurality of reflected light beams; and controlling a focusing operation by driving an objective lens using the control signal.

According to another aspect, the generating of the control signal includes detecting a plurality of focus error signals corresponding to the plurality of reflected light beams, and generating the control signal by applying a defocus corresponding to an average of the plurality of focus error signals to a focus servo signal.

According to another aspect, the generating of the control signal includes detecting a plurality of focus error signals corresponding to the plurality of reflected light beams, and generating the control signal by applying a defocus, which corresponds to an average of a focus error signal that is generated first among the plurality of focus error signals and a focus error signal having a highest level difference in relation to the focus error signal which is generated first among the other focus error signals, to a focus servo signal.

According to another aspect, the generating of the control signal includes detecting a plurality of sum signals corresponding to the plurality of reflected light beams, generating a spherical aberration compensating control signal to adjust a position of a compensating lens to compensate for a spherical aberration using a sum signal corresponding to a reference light beam, in which a focus error signal is generated first among the plurality of focus error signals, among the plurality of sum signals, and adjusting the position of the compensating lens using the spherical aberration compensating control signal.

According to another aspect of the present invention, a method of controlling a multi-channel recording and/or reproducing apparatus includes emitting a plurality of light beams from a plurality of light sources to a plurality of tracks of an information storage medium, detecting the plurality of light beams reflected by the tracks of the information storage medium, generating a control signal to equalize and control aberrations produced due to a wavelength difference between the light sources or a displacement difference on an optical axis between the light sources based on detection signals generated according to the plurality of reflected light beams, and compensating for a spherical aberration by driving a compensating lens using the control signal.

According to another aspect, the generating of the control signal includes detecting a plurality of focus error signals corresponding to the plurality of reflected light beams, detecting a plurality of sum signals corresponding to the plurality of reflected light beams; generating a spherical aberration compensating control signal to adjust a position of the compensating lens to compensate for the spherical aberration using a sum signal for a reference light beam, in which a focus error signal is generated first among the plurality of focus error signals, among the plurality of sum signals, and adjusting the position of the compensating lens using the spherical aberration compensating control signal.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a graph illustrating defocus compared to jitter and defocus compared to a wavefront aberration as a defocus increases in an optical pickup system for a blu-ray disc (BD);

FIG. 2 is a graph illustrating different wavefront aberrations of light spots formed on a disc resulting from a displacement difference on an optical axis between light sources; and

FIG. 3 illustrates a multi-channel optical recording and/or reproducing apparatus according to an embodiment of the present invention;

FIG. 4 illustrates focus error signals calculated when a displacement difference on an optical axis between two light sources is 40 μm;

FIG. 5 illustrates a multi-channel optical recording and/or reproducing apparatus according to another embodiment of the present invention; and

FIG. 6 illustrates a multi-channel optical recording and/or reproducing apparatus according to still another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

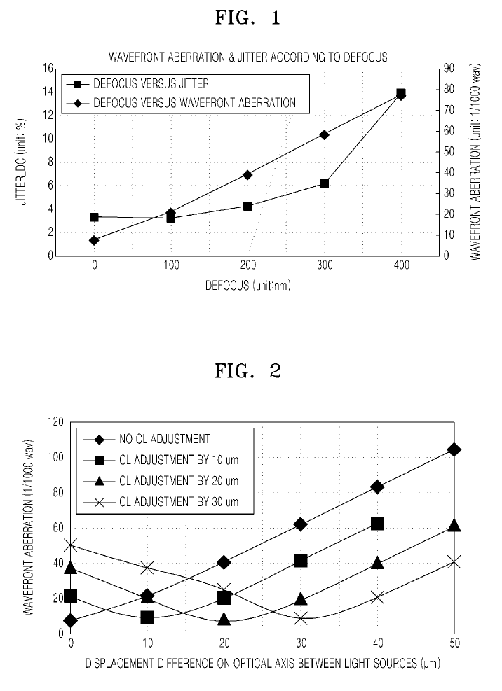

FIG. 1 is a graph illustrating defocus compared to jitter and defocus compared to a wavefront aberration as a defocus increases in an optical pickup system for a blu-ray disc (BD). Referring to FIG. 1, as a defocus increases, wavefront aberration increases linearly at the defocus increases from 0 to 400 nm. Jitter increases at a rate slower than the wavefront aberration as the defocus increases from 0 to 300 nm, but increases at a greater rate than the wavefront aberration when the amount of defocus increases from approximately 300 nm and greater. Accordingly, in the case of a multi-channel optical pickup using a plurality of light sources, the light sources should be carefully assembled and adjusted so as not to form light spots having different wavefront aberrations on an optical disc.

FIG. 2 is a graph illustrating different wavefront aberrations of light spots formed on a disc resulting from a displacement difference on an optical axis between light sources. Referring to FIGS. 1 and 2, assuming that the collimating lens has not been adjusted, at a defocus of 200 nm, a wavefront aberration of about 40 mλ is produced (FIG. 1), and as a result, a displacement difference between light sources is 20 μm (FIG. 2). Accordingly, there is a correlation between a defocus and a displacement difference on an optical axis between light sources.

FIG. 2 shows results of when a collimating lens (CL) is used as a spherical aberration compensating device for a reference light source which has no CL adjustment, a light source having a CL adjustment of 10 μm, a light source having a CL adjustment of 20 μm, and a light source having a CL adjustment of 30 μm. An aberration of a reference light source (i.e., a light source having no CL adjustment) increases linearly as the displacement difference increases from 0 to 50 μm, whereas the aberrations of the three other light sources each initially decrease at various displacement differences, and then increase as the displacement difference increases.

Referring to FIG. 2, a graph obtained when the position of the CL is adjusted by 20 μm will now be compared with a graph obtained when the position of the CL is not adjusted. In FIG. 2, the x-axis represents a displacement difference on an optical axis between light sources, the y-axis represents a wavefront aberration caused by the displacement difference, and the four lines represent measurements of the two light beams taken when the CL is not adjusted, adjusted by 10 μm, adjusted by 20 μm, and adjusted by 30 μm. When the CL is moved from 0 μm to 20 μm, an aberration between two light beams changes from less than 10 mλ to approximately 40 mλ when the displacement difference is 0 μm. Further, when the CL is moved from 0 μm to 20 μm, an aberration of 80 mλ in the case of two light beams having a displacement difference of 40 μm on an optical axis decreases to 40 mλ, such that the aberrations of the two light beams approach equalization and the range of a displacement difference on an optical axis, where both of the two light sources can maintain an aberration of about 40 mλ, increases about twice from 20 to 40 μm. Thus, as shown in FIG. 2, adjusting the CL (e.g., in increments of 10 μm, 20 μm, and 30 μm) can decrease the wavefront aberration caused by a displacement difference on an optical axis between light sources. It is understood that the CL is not limited to being adjusted in 10 μm increments.

Aspects of the present invention provide a multi-channel optical recording and/or reproducing apparatus and a method of controlling the same, which reduces a difference in performance due to differing wavefront aberrations between channels of a multi-channel optical pickup and increases an optical axis adjustment tolerance by equalizing aberrations produced due to a displacement difference on an optical axis between the light sources, a wavelength difference between the light sources, or a distance between the light sources as shown in FIG. 1.

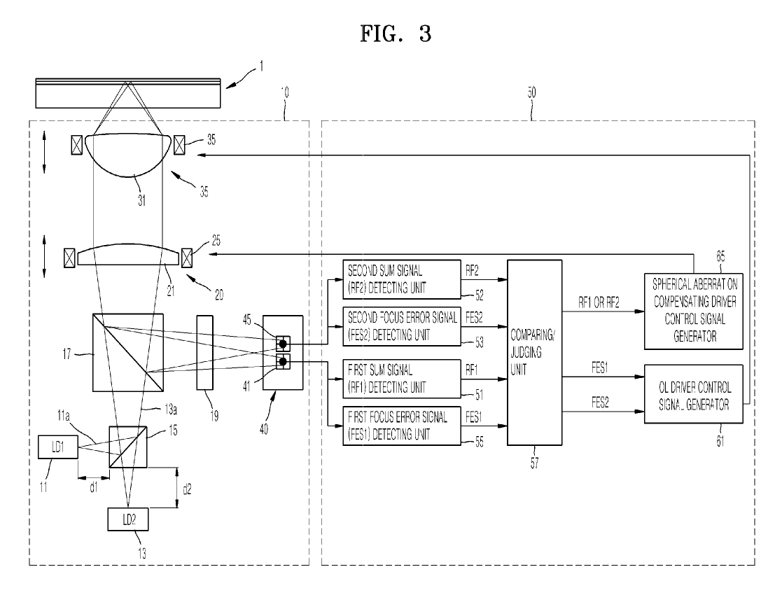

Aspects of the present invention will now be described more fully with reference to the accompanying drawings, in which exemplary embodiments of the invention are shown. FIG. 3 illustrates a multi-channel optical recording and/or reproducing apparatus according to an embodiment of the present invention. Referring to FIG. 3, the multi-channel optical recording/reproducing apparatus includes an optical pickup 10 including a plurality of light sources, the optical pickup 10 being adapted to emit a plurality of light beams to a plurality of tracks of an optical disc 1, and to detect a plurality of light beams reflected by the tracks of the optical disc 1, and a control signal generating unit 50 to generate a control signal that equalizes and controls aberrations produced due to a wavelength difference or a displacement difference on an optical axis between the plurality of light sources, the control signal being generated from detection signals generated from the plurality of reflected light beams. The optical disc 1 can be various types, such as, for example, a blu-ray disc (BD), an HD-DVD, a DVD, etc.

In FIG. 3, the optical pickup 10 includes a first light source 11 and a second light source 13 to respectively emit a first light beam 11a and a second light beam 13a which have a wavelength difference of 10 nm or less therebetween, an objective lens (OL) 31 to focus the first light beam 11a and the second light beam 13a respectively emitted by the first light source 11 and the second light source 13 on the optical disc 1, an OL lens driver 35 to vertically sweep the OL 31 along an optical axis, a spherical aberration compensating unit 20 to minimize a spherical aberration when a signal is reproduced or recorded on a recording layer of the optical disc 1 using the light beams focused by the OL 31, and a light detecting unit 40 to receive first and second light beams 11a and 13a emitted by the first and second light sources 11 and 13 which are reflected by the optical disc 1. The optical pickup 10 may further include an optical path changer 17 to direct the first and second light beams 11a and 13a emitted by the first and second light sources 11 and 13 to the optical disc 1 and to direct the first and second light beams 11a and 13a reflected by the optical disc 1 to the light detecting unit 40. The optical pickup 10 may further include an optical path coupler 15 to couple optical paths of the first and second light beams 11a and 13a respectively emitted by the first and second light sources 11 and 13.

According to an aspect of the present invention, the first and second light sources 11 and 13 are embodied as semiconductor lasers 11 and 13 to emit the first and second light beams 11a and 13a which theoretically have the same wavelength bands. In reality, however, it is difficult to manufacture semiconductor lasers which emit laser beams having exactly the same wavelength. As a result, the first and second light beams 11a and 13a have a slight wavelength difference.

Accordingly, even though the semiconductor lasers 11 and 13 theoretically emit the laser beams 11a and 13a to have the same wavelength, a slight wavelength difference between the first and second light beams 11a and 13a is likely to exist. The first and second light sources 11 and 13 used in the multi-channel optical recording and/or reproducing apparatus of FIG. 3 may have a wavelength difference of 10 nm or less, but aspects of the present invention are not limited thereto, and semiconductor lasers having a wavelength difference of more than 10 nm may be used as the first and second light sources 11 and 13.

The OL 31 is configured for use with the format of the optical disc 1 applied to the multi-channel optical recording and/or reproducing apparatus of FIG. 3. For example, when the multi-channel optical recording and/or reproducing apparatus is used for a single layer (SL) or a multi-layer (ML) (BD), the OL 31 may have a numerical aperture of about 0.85 and be designed to be optimized for a BD having a protective layer with a thickness of about 0.1 mm. In this case, the first and second light sources 11 and 13 may be blue semiconductor lasers to emit first and second light beams 11a and 13a having wavelengths of about 405 nm. However, aspects of the present invention are not limited thereto, and the numerical aperture of the OL 31 and the wavelengths of the first and second light beams 11a and 13a may instead be adjusted to comply with other formats, such as HD-DVD, etc.

The spherical aberration compensating unit 20 includes a compensating lens 21 and a spherical aberration compensating driver 25 to vertically sweep the compensating lens 21 along the optical axis. The compensating lens 21 may be a CL to collimate the first and second light beams 11a and 13a emitted as divergent beams from the first and second light sources 11 and 13. The spherical aberration compensating driver 25 of the spherical aberration compensating unit 20 varies the position of the compensating lens 21 back and forth on the optical axis so that a spherical aberration is minimized when a signal is recorded or reproduced on the recording layer of the optical disc 1 using the first and second light beams 11a and 13a focused by the objective lens 31, thereby compensating for spherical aberration.

The optical path changer 17 may be a beam splitter that transmits and reflects incident light at a predetermined ratio. According to an aspect of the present invention, the optical path changer 17 may be a polarizing beam splitter 17 to transmit or to reflect incident light according to polarization, and a quarter wave plate (not shown) may be further disposed between the optical path changer 17 and the OL 31 to change the polarization of incident light. Since a structure including the polarizing beam splitter 17 and the quarter wave plate is well known in this field, a detailed explanation thereof will not be given. Further, it is understood that the optical path changer 17 is not required to be a polarizing beam splitter 17.

The optical path coupler 15 may be a beam splitter.

The light detecting unit 40 is configured to receive light reflected by the optical disc 1 and to detect focus error signals and sum signals which indicate the intensity of the reflected light. The light detecting unit 40 may include a first light receiving unit 41 and a second light receiving unit 45 to respectively receive the first and second light beams 11a and 13a reflected by the recording layer of the optical disc 1. According to an aspect of the present invention, each of the first and second light receiving units 41 and 45 may have a four-division structure as shown in FIG. 3 to detect focus error signals using an astigmatic method. Here, the four-division structure of the first and second light receiving units 41 and 45 is only exemplary and the structure of the first and second light receiving units 41 and 45 is not limited to this.

An astigmatic lens 19 is further disposed on an optical path between the optical path changer 17 and the light detecting unit 40 to detect focus error signals using an astigmatic method.

When the first and second light sources 11 and 13 of the optical pickup 10 constructed as described above are assembled, a displacement error on the optical axis corresponds to a difference between a distance d1 between the first light source 11 and the optical path coupler 15 and a distance d2 between the second light source 13 and the optical path coupler 15. When the first and second light sources 11 and 13 are assembled with no displacement error on the optical axis, the distances d1 and d2 are equal to each other. Even in this case, since there is a wavelength difference between the first and second light beams 11a and 13a respectively emitted by the first and second light sources 11 and 13, a light spot formed by the other of the first light beam 11a and the second light beam 13a which is not the reference light beam will have spherical aberration. For example, when it is assumed that the first light beam 11a is a reference light beam, a light spot formed by the second light beam 13a will have spherical aberration. Accordingly, the spherical aberration compensating unit 20 operates to compensate for the spherical aberration with respect to the second light beam 13a. In contrast, when it is assumed that the second light beam 13a is a reference light beam, a light spot formed by the first light beam 11a will have a spherical aberration, and the spherical aberration compensating unit 20 operates to compensate for the spherical aberration with respect to the first light beam 11a.

The control signal generating unit 50, which generates a control signal to equalize and control aberrations occurring due to a displacement difference on the optical axis or a wavelength difference between the light sources 11 and 13 based on detection signals of the first and second light beams 11a and 13a reflected by the optical disc 1, includes first and second focus error signal detecting units 55 and 53, and an OL driver control signal generator 61. The control signal generating unit 50 further includes first and second sum signal detecting units 51 and 52 used to compensate for spherical aberration, a comparing/judging unit 57, and a spherical aberration compensating driver control signal generator 65.

The first and second focus error signal detecting units 55 and 53 respectively generate first and second focus error signals FES1 and FES2 from detection signals of the first and second light receiving units 41 and 45 after respectively receiving the first and second light beams 11a and 13a reflected by the optical disc 1. The first sum signal detecting unit 51 generates a first sum signal RF1 summing all detection signals of the first light receiving unit 41. The second sum signal detecting unit 52 generates a second sum signal RF2 summing all detection signals of the second light receiving unit 45. It is understood that more than two sum signal detecting units may be used.

The comparing/judging unit 57 compares the first and second focus error signals FES1 and FES2 to determine which of the two focus error signals is generated first, and inputs a corresponding one of the sum signals RF1 and RF2 for light in which a focus error signal is first generated to the spherical aberration compensating driver control signal generator 65 to be used to generate a second control signal and thereby adjust the position of the compensating lens 21. The one of the first and second light beams 11a and 13a in which a focus error signal is first generated is set as a reference light beam.

The OL driver control signal generator 61 generates the control signal that adds a defocus corresponding to an average of the first and second focus error signals FES1 and FES1 to a focus servo signal.

According to aspects of the present invention, the multi-channel optical pickup 10 of FIG. 3 may record and/or reproduce data in three or more tracks at the same time. In this case, the focus error signal detecting units may be configured to detect three or more focus error signals, and the sum signal detecting units may be configured to detect three or more sum signals. The comparing/judging unit 57 sets a light beam, in which a focus error signal is generated first among three or more light beams emitted to the optical disc 1, as a reference light beam, and inputs a sum signal for the reference light beam to the spherical aberration compensating driver control signal generator 65 to generate the second control signal which is used to adjust the position of the compensating lens 21.

The OL driver control signal generator 61 generates the control signal which is used to apply a defocus, corresponding to an average of the zero crossing point of a focus error signal generated by the reference light beam and a focus error signal having a highest level difference among focus error signals generated by the other light beams, to a focus servo signal. As a result, aberrations of light spots formed by three or more light beams on the optical disc 1 are equalized such that all channels can maintain similar performance. Since a structure to detect three or more focus error signals can be inferred from the description of FIG. 3, a detailed explanation thereof and modifications of the optical pickup 10 and the control signal generating unit 50 will not be given.

Although a plurality of focus error signals is input to the OL driver control signal generator 61 through the comparing/judging unit 57 in FIG. 3, aspects of the present invention are not limited thereto. That is, the plurality of focus error signals may be directly input from the focus error signal detecting units to the OL driver control signal generator 61 without passing through the comparing/judging unit 57. In this case, for example, the OL driver control signal generator 61 determines an average of a focus error signal which is first generated and a focus error signal which has a highest level difference.

The control signal generated by the OL driver control signal generator 61 is applied to the OL driver 35 to control a focus of the OL 31. The spherical aberration compensating driver control signal generator 65 generates a second control signal to compensate for a spherical aberration from a sum signal for a reference light beam. The second control signal generated by the spherical aberration compensating driver control signal generator 65 is applied to the spherical aberration compensating driver 25.

When one of the first and second light beams 11a and 11b for which a focus error signal is generated first is set as a reference light beam, the spherical aberration compensating driver control signal generator 65 generates the second control signal to adjust the position of the compensating lens 21 of the spherical aberration compensating unit 20 so that a sum signal detected with respect to the reference light beam is maximized.

The multi-channel optical recording and/or reproducing apparatus according to aspects of the present invention constructed as described above reduces a difference in recording and reproducing performance between the channels of the multi-channel optical pickup 10 resulting from light spots having different aberrations by equalizing aberrations occurring due to a displacement difference on the optical axis between the light sources 11 and 13 or a wavelength difference between the light sources 11 and 13 as will be seen below. Also, the multi-channel optical recording and/or reproducing apparatus according to aspects of the present invention increases an optical axis adjustment tolerance.

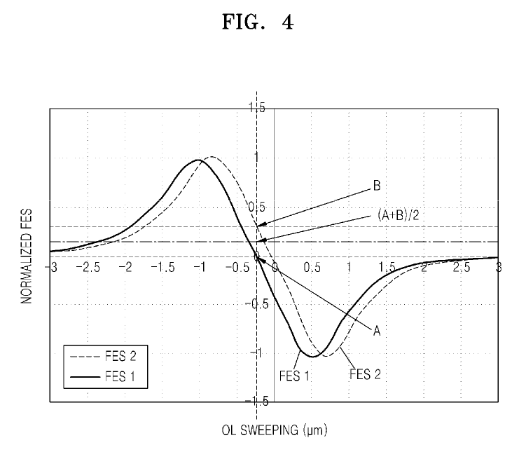

FIG. 4 is a graph illustrating focus error signals FES1 and FES2 which are calculated when a displacement difference on an optical axis between two light sources is 40 μm. The two focus error signals FES1 and FES2, which are generated according to two light spots formed on the optical disc 1 having a displacement difference on the optical axis between the light sources 11 and 13 and detected by the first and second focus error signal detecting units 55 and 53 of FIG. 3, are generated at a predetermined interval as shown in FIG. 4. As shown in FIG. 4, the two focus error signals FES1 and FES2 are not simultaneously generated.

Referring to FIG. 4, when a focus servo operation is carried out at a point where the first focus error signal FES1 is zero, a signal is recorded and/or reproduced while a light spot generating the second focus error signal FES2 is defocused by hundreds of nanometers (nm), thereby deteriorating recording and/or reproducing performance. Similarly, when a focus servo is carried out at a point where the second focus error signal FES2 is zero, a signal is recorded and/or reproduced while a light spot generating the first focus error signal FES1 is defocused by hundreds of nanometers (nm), thereby also deteriorating recording and/or reproducing performance.

Accordingly, when there exists a displacement difference on an optical axis between light sources and a focus servo is carried out with one light source as a reference light source, recording and/or reproducing performance using the other light source is inevitably deteriorated. Even though an aberration of one light spot is minimized, thus achieving good recording and/or reproducing performance for that light spot, if the performance of the other light spot is poor, the multi-channel optical pickup 10 cannot perform well.

The multi-channel optical recording and/or reproducing apparatus according to aspects of the present invention enables all the light spots to have similar recording and/or reproducing performance by equalizing an aberration of a light spot which has a smaller aberration with and an aberration of a light spot which has a larger aberration and a poor recording and/or reproducing performance. To this end, the multi-channel optical recording and/or reproducing apparatus according to aspects of the present invention carries out a focus servo operation using focus error signals for all the light spots used to record and/or reproduce data to and/or from the optical disk 1, not just a focus error signal for one light spot.

As shown in FIG. 4, when the point where the first focus error signal FES1 is zero is A and the level of the second focus error signal FES2 at the point A is B, the multi-channel optical recording and/or reproducing apparatus according to aspects of the present invention carries out a focus servo operation based on a point (A+B)/2, which is an average of the point A, i.e., the zero crossing point of FES1, and the level B. As a result, both of the light spots emitted from the plurality of light sources 11 and 13 have similar defocuses and aberrations on the optical disc 1. Thus, since the aberrations of the light spots 11 and 13 formed on the optical disc 1 are similar to one another, the multi-channels become similar to one another in recording and/or reproducing performance.

The spherical aberration compensating unit 20 of FIG. 3 changes the position of the compensating lens 21 back and forth on the optical axis when the focus servo operation is carried out to gradually adjust spherical aberrations of light spots formed on the optical disc 1, thereby making it possible to optimize information reproduction signals RF and jitters.

In the case of a single channel, a spherical aberration compensating mechanism is generally moved to optimize information reproduction signals RF when a focus servo operation is carried out. Likewise, in the case of the multi-channel optical pickup 10, the spherical aberration compensating lens 21 is moved when a focus servo operation is carried out in order to optimize information reproduction signals RF. According to an aspect of the present invention, the focus servo operation is carried out at a point which is an average of the first and second focus error signals FES1 and FES2.

Since a difference between the first and second focus error signals FES1 and FES2 produced due to a displacement difference on an optical axis or a wavelength difference is not reduced, but instead is shifted on a time axis, when the spherical aberration compensating lens 21 is moved, the focus servo operation should be carried out at a point, e.g., (A+B)/2, that is an average of the two focus error signals FES1 and FES2 in order to optimize aberrations of two light spots.

Although FIG. 3 illustrates that the optical pickup 10 of the multi-channel optical recording and/or reproducing apparatus includes two light sources, aspects of the present invention are not limited thereto. That is, the focus servo concept according to aspects of the present invention may be applied in an optical pickup including two or more light sources and light receiving units corresponding in number to a number of the light sources. When three of more focus error signals are used, two focus error signals, which are farthest from each other on a time axis, among a plurality of focus error signals generated by light beams emitted by the three or more light sources to the optical disc 1 are detected. Then, a focus servo operation is carried out at a point that is an average of the detected two focus error signals.

According to an aspect of the present invention, the first and second light sources 11 and 13 of FIG. 3 may be semiconductor lasers each having one light emitting point or a plurality of light emitting points. Since a semiconductor laser array may suffer from an overheating problem, each semiconductor laser array should have a limited number of light emitting points in order to prevent overheating. When the number of required channels is greater than the number of light emitting points, a semiconductor laser array may be separated into two or more semiconductor laser arrays. The multi-channel optical recording and/or reproducing apparatus having the two laser diodes 11 and 13 shown in FIG. 4 is particularly useful in this case.

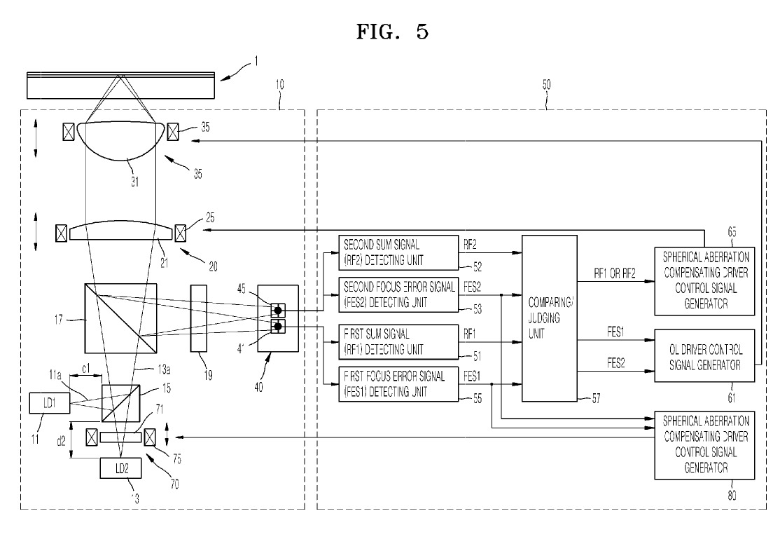

FIG. 5 illustrates a multi-channel optical recording and/or reproducing apparatus according to another embodiment of the present invention. The multi-channel optical recording and/or reproducing apparatus of FIG. 5 is different from the multi-channel optical recording and/or reproducing apparatus of FIG. 3 because the multi-channel optical recording and/or reproducing apparatus of FIG. 5 additionally has a second spherical aberration compensating unit 70 disposed at a position before a position where the optical paths of the first and second light beams 11a and 13a, which are respectively emitted by the first and second light sources 11 and 13, are coupled to each other by the optical path coupler 15, and a second spherical aberration compensating driver control signal generator 80 used to drive the second spherical aberration compensating unit 70. The second spherical aberration compensating unit 70 includes a second spherical aberration compensating lens 71 and a second spherical aberration compensating driver 75 to drive the spherical aberration compensating lens 71.

Referring to FIG. 5, first and second focus error signals FES1 and FES2, which are generated with respect to the first and second light beams 11a and 13a respectively emitted by the first and second light sources 11 and 13, are matched with each other by adjusting the compensating lens 71 of the second spherical aberration compensating unit 70 before the aforesaid operation of the multi-channel optical recording and/or reproducing apparatus of FIG. 3 is performed.

The first and second focus error signals FES1 and FES2 obtained from the first and second light beams 11a and 11b are matched with each other by adjusting the second spherical aberration compensating unit 70 and then performing the function described with reference to the multi-channel optical recording and/or reproducing apparatus of FIG. 3. As a result, aberrations with respect to the first and second light beams 11a and 13a respectively emitted by the first and second light sources 11 and 13 are distributed in a more uniform fashion.

According to an aspect of the present invention, the first and second light sources 11 and 13 of FIG. 5 are semiconductor lasers each having one light emitting point, or semiconductor laser arrays each having a plurality of light emitting points.

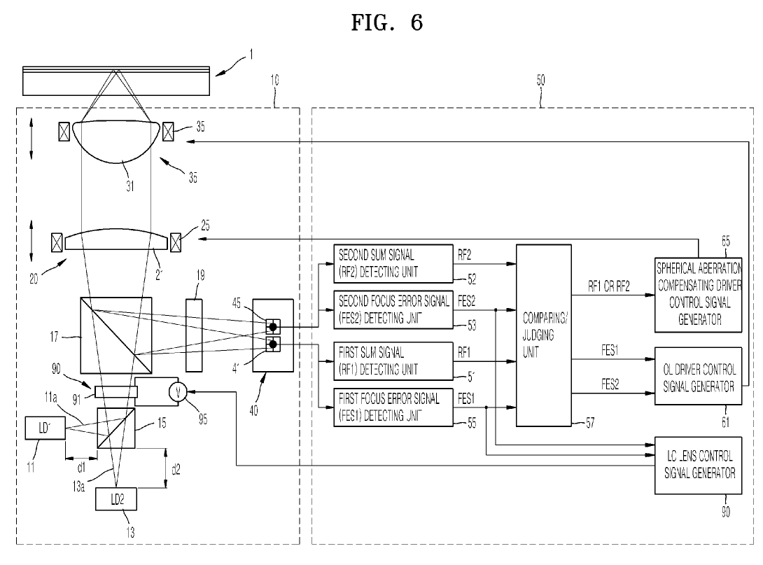

FIG. 6 illustrates a multi-channel optical recording and/or reproducing apparatus according to still another embodiment of the present invention. When compared with the aforesaid multi-channel optical recording and/or reproducing apparatuses shown in FIGS. 3 and 5, the multi-channel optical recording and/or reproducing apparatus shown in FIG. 6 includes first and second light sources 11 and 13 to emit first and second light beams 11a and 13a which have orthogonal polarizations to each other, and a polarizing beam splitter to reflect the first light beam 11a and transmit the second light beam 13a as the optical path coupler. Further, the multi-channel optical recording and/or reproducing apparatus shown in FIG. 6 has a third spherical aberration compensating unit 90 disposed at a position after a position where the first and second light beams 11a and 13a are coupled to each other, that is, disposed between the optical path coupler 15 and the optical path changer 17, and includes a liquid crystal lens 91 and a power source 95 to drive the liquid crystal lens 91.

Since the liquid crystal lens 91 can be configured to act as a polarizing element, the liquid crystal lens 91 may be controlled to not react to the second light beam 13a while being controlled to react to the first light beam 11a, or alternatively may be controlled to not react to the first light beam 11a while being controlled to not react to the second light beam 13a. Here, when a light beam does “not react” to the liquid crystal lens 91, this “not reacting” refers to when a light beam incident on the liquid crystal lens 91 is transmitted through the liquid crystal lens 91 without convergence or divergence, as if the light beam is passing through a general glass plate without magnification.

According to an aspect of the present invention, the liquid crystal lens 91 is designed to have a constant magnification at a fixed input voltage V. Thus, as the input voltage changes, a refractive index in the liquid crystal lens 91 changes, and thus the magnification changes.

Accordingly, while the multi-channel optical recording and/or reproducing apparatus of another embodiment of the present invention as described in referring to FIG. 5 uses the second spherical aberration compensating unit 70 before coupling the optical paths of the first and second light beams 11a and 13a in order to match the focus error signals FES1 and FES2 for the first and second light beams 11a and 13a, the multi-channel optical recording and/or reproducing apparatus of the embodiment shown in FIG. 6 uses the liquid crystal lens 91, which changes magnification as the input voltage V changes. That is, by adjusting the voltage of the liquid crystal lens 91, the first and second focus error signals FES1 and FES2 for the first and second light beams 11a and 13a are matched to each other. Then, the function described with reference to FIG. 3 is performed, and the aberrations of the first and second light beams 11a and 13a can be distributed more uniformly.

According to an aspect of the present invention, the first and second light sources 11 and 13 of FIG. 6 are semiconductor lasers each having one light emitting point, or semiconductor laser arrays each having a plurality of light sources.

As described above, since the multi-channel optical recording and/or reproducing apparatuses according to aspects of the present invention enable a plurality of light spots formed on the optical disc 1 to have similar aberration performance, the position of the spherical aberration compensating unit 20 (FIG. 3) or the working distance of the OL 31 (FIG. 3) can be adjusted so that a jitter performance difference between channels is maintained below 2%.

Furthermore, as described above, since the multi-channel optical recording and/or reproducing apparatuses and the method of controlling the same according to aspects of the present invention equalize aberrations of light spots formed by the multi-channel optical pickup 10 (FIG. 3) using the plurality of light sources 11 and 13 (FIG. 3) and stabilize recording and/or reproducing performance, a multi-channel optical recording and/or reproducing apparatus having a high data transfer rate (DTR) and high performance is realized.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A multi-channel optical recording and/or reproducing apparatus comprising:
an optical pickup including a plurality of light sources, the optical pickup to emit a plurality of light beams to a corresponding plurality of tracks of an information storage medium and to detect the plurality of light beams reflected by the corresponding plurality of tracks of the information storage medium; and
a control signal generating unit to generate a control signal which equalizes and controls aberrations produced due to a wavelength difference between the plurality of light sources, a displacement difference on an optical axis between the light sources, or a distance between the light sources, based on detection signals generated according to the plurality of reflected light beams.

2. The multi-channel optical recording and/or reproducing apparatus of claim 1, wherein the control signal generating unit comprises:
a focus error signal detecting unit to detect a plurality of focus error signals corresponding to the plurality of reflected light beams; and
an objective lens driver control signal generator to generate the control signal which applies a defocus corresponding to an average of the focus error signals to a focus servo signal.

3. The multi-channel optical recording and/or reproducing apparatus of claim 2, wherein the optical pickup further comprises:
an objective lens to focus the plurality of light beams on the information storage medium; and
a driver to drive the objective lens,
wherein a focusing operation is controlled using the control signal generated by the objective lens driver control signal generator.

4. The multi-channel optical recording and/or reproducing apparatus of claim 3, wherein the control signal generating unit further comprises a comparing/judging unit to compare the plurality of focus error signals and to judge which focus error signal is generated first.

5. The multi-channel optical recording and/or reproducing apparatus of claim 4, wherein the optical pickup further comprises a spherical aberration compensating unit including a compensating lens to compensate for a spherical aberration and a second driver to drive the compensating lens,
wherein the control signal generating unit further comprises:
a sum signal detecting unit to detect a plurality of sum signals corresponding to the plurality of reflected light beams; and
a spherical aberration compensating driver control signal generator to generate a second control signal which adjusts a position of the compensating lens of the spherical aberration compensating unit,
wherein the comparing/judging unit inputs a sum signal for a reference light beam, in which a focus error signal is generated first, among the plurality of sum signals to the spherical aberration compensating driver control signal generator to generate the second control signal.

6. The multi-channel optical recording and/or reproducing apparatus of claim 5, wherein the position of the compensating lens is adjusted so that a level of the sum signal detected with respect to the reference light beam is maximized.

7. The multi-channel optical recording and/or reproducing apparatus of claim 1, wherein the control signal generating unit comprises:
a focus error signal detecting unit to detect a plurality of focus error signals corresponding to the plurality of reflected light beams; and
an objective lens driver control signal generator to generate the control signal to set a light beam, in which a focus error signal is generated first among the plurality of light beams, as a reference light beam and to apply a defocus corresponding to an average of a zero crossing point of a focus error signal corresponding to the reference light beam and a point corresponding to the zero crossing point for a focus error signal having a highest level difference in relation to the focus error signal which is generated first among the focus error signals of the other focus error signals to a focus servo signal.

8. The multi-channel optical recording and/or reproducing apparatus of claim 7, wherein the optical pickup comprises:
an objective lens to focus the plurality of light beams on the information storage medium; and
a driver to drive the objective lens,
wherein a focusing operation is controlled using the control signal generated by the objective lens driver control signal generator.

9. The multi-channel optical recording and/or reproducing apparatus of claim 8, wherein the control signal generating unit further comprises a comparing/judging unit to compare the plurality of focus error signals and to judge which focus error signal is generated first.

10. The multi-channel optical recording and/or reproducing apparatus of claim 9, wherein the optical pickup further comprises a spherical aberration compensating unit including a compensating lens to compensate for a spherical aberration and a second driver to drive the compensating lens,
the control signal generating unit further comprises:
a sum signal detecting unit to detect a plurality of sum signals corresponding to the plurality of reflected light beams; and
a spherical aberration compensating driver control signal generator to generate a second control signal which adjusts a position of the compensating lens of the spherical aberration compensating unit, and
the comparing/judging unit inputs a sum signal for a reference signal, in which a focus error signal is generated first, among the plurality of sum signals to the spherical aberration compensating driver control signal generator to generate the second control signal.

11. The multi-channel optical recording and/or reproducing apparatus of claim 10, wherein the position of the compensating lens is adjusted so that a level of the sum signal detected with respect to the reference light beam is maximized.

12. The multi-channel optical recording and/or reproducing apparatus of claim 1, wherein the optical pickup further comprises a spherical aberration compensating unit including a compensating lens to compensate for a spherical aberration and a driver to drive the compensating lens,
the control signal generating unit comprises:
a focus error signal detecting unit to detect a plurality of focus error signals corresponding to the plurality of reflected light beams;
a sum signal detecting unit to detect a plurality of sum signals corresponding to the plurality of reflected light beams;
a spherical aberration compensating driver control signal generator to generate a second control signal which adjusts a position of the compensating lens of the spherical aberration compensating unit; and
a comparing/judging unit to compare the plurality of focus error signals and to judge which focus error signal is generated first, and to input a sum signal for a reference light beam, in which a focus error signal is generated first, among the plurality of sum signals to the spherical aberration compensating driver control signal generator to generate the second control signal.

13. The multi-channel optical recording and/or reproducing apparatus of claim 12, wherein the position of the compensating lens is adjusted so that a level of the sum signal detected with respect to the reference light beam is maximized.

14. The multi-channel optical recording and/or reproducing apparatus of claim 1, wherein the plurality of light sources includes a first light source and a second light source to respectively emit a first light beam and a second light beam, and the optical pickup further comprises:
an optical path coupler to couple optical paths of the first and second light beams respectively emitted by the first and second light sources; and
a second spherical aberration compensating unit disposed on the optical path of the first or second light beam at a position before a position where the optical paths of the first and second light beams respectively emitted by the first and second light beams are coupled to each other.

15. The multi-channel optical recording and/or reproducing apparatus of claim 1, wherein the plurality of light sources include a first light source and a second light source to respectively emit a first light beam and a second light beam which have orthogonal polarizations to each other, and the optical pickup further comprises a polarizing beam splitter to couple optical paths of the first and second light beams respectively emitted by the first and second light sources.

16. The multi-channel optical recording and/or reproducing apparatus of claim 15, wherein the optical pickup further comprises a spherical aberration compensating unit disposed at a position on an optical path after a position where the optical paths of the first and second light beams respectively emitted by the first and second light sources are coupled to each other, the spherical aberration compensating unit comprising:
a liquid crystal lens to act as a polarizing element; and
a power source to drive the liquid crystal lens to match focus error signals based on the plurality of reflected light beams.

17. The multi-channel optical recording and/or reproducing apparatus of claim 1, wherein the optical pickup simultaneously emits the plurality of light beams to the corresponding plurality of tracks.

18. A method of controlling a multi-channel optical recording and/or reproducing apparatus, the method comprising:
emitting a plurality of light beams from a plurality of light sources to a plurality of tracks of an information storage medium;
detecting the plurality of light beams reflected by the tracks of the information storage medium;
generating a control signal to equalize and control aberrations produced due to a wavelength difference between the light sources or a displacement difference on an optical axis between the light sources based on detection signals generated according to the plurality of reflected light beams; and
controlling a focusing operation by driving an objective lens using the control signal.

19. The method of claim 18, wherein the generating of the control signal comprises:
detecting a plurality of focus error signals corresponding to the plurality of reflected light beams; and
generating the control signal by applying a defocus, which corresponds to an average of the plurality of focus error signals, or to an average of a focus error signal which is generated first among the plurality of focus error signals and a focus error signal having a highest level difference in relation to the focus error signal which is generated first among the other focus error signals, to a focus servo signal.

20. The method of claim 19, further comprising:
detecting a plurality of sum signals corresponding to the plurality of reflected light beams;
generating a spherical aberration compensating control signal to adjust a position of a compensating lens to compensate for a spherical aberration using a sum signal corresponding to a reference light beam, in which a focus error signal is generated first among the plurality of focus error signals, among the plurality of sum signals; and
adjusting the position of the compensating lens using the spherical aberration compensating control signal.

21. The method of claim 20, wherein the adjusting of the position of the compensating lens comprises adjusting the compensating lens so that a level of the sum signal detected with respect to the reference signal is maximized.

22. The method of claim 18, wherein the emitting of the plurality of light beams comprises simultaneously emitting the plurality of light beams from the plurality of light sources to the plurality of tracks.

23. A method of controlling a multi-channel recording and/or reproducing apparatus, the method comprising:
emitting a plurality of light beams from a plurality of light sources to a plurality of tracks of an information storage medium;
detecting the plurality of light beams reflected by the tracks of the information storage medium;
generating a control signal to equalize and control aberrations produced due to a wavelength difference between the light sources or a displacement difference on an optical axis between the light sources based on detection signals generated according to the plurality of reflected light beams; and
compensating for a spherical aberration by driving a compensating lens using the control signal.

24. The method of claim 23, further comprising:
detecting a plurality of focus error signals corresponding to the plurality of reflected light beams;
detecting a plurality of sum signals corresponding to the plurality of reflected light beams;
generating a spherical aberration compensating control signal to adjust a position of the compensating lens to compensate for the spherical aberration using a sum signal for a reference light beam, in which a focus error signal is generated first among the plurality of focus error signals, among the plurality of sum signals; and
adjusting the position of the compensating lens using the spherical aberration compensating control signal.

25. The method of claim 24, wherein the adjusting of the position of the compensating lens comprises adjusting the compensating lens so that a level of the sum signal detected with respect to the reference light beam is maximized.

26. The method of claim 23, wherein the emitting of the plurality of light beams comprises simultaneously emitting the plurality of light beams from the plurality of light sources to the plurality of tracks.

27. The method of claim 23, wherein the emitting of the plurality of light beams comprises emitting three or more light beams, and the generating of the control signal comprises using an average of two focus error signals corresponding to two of the light beams which are farther from each other on a time axis among the three or more light beams.

28. A multi-channel optical recording and/or reproducing apparatus comprising:
an optical pickup including first and second light sources to emit first and second light beams to corresponding tracks of an information storage medium and to detect the first and second light beams reflected by the corresponding tracks of the information storage medium; and
a control signal generating unit to generate a control signal based on an average value of first and second focus error signals generated according to the detected first and second light beams, wherein the control signal is used to perform a focusing operation.

29. The multi-channel optical recording and/or reproducing apparatus of claim 28, wherein the control signal generating unit generates the average value by averaging a value of a zero crossing point of the first focus error signal and a value of the second focus error signal at a position corresponding to the zero crossing point of the first focus error signal.

30. The multi-channel optical recording and/or reproducing apparatus of claim 28, wherein the control signal generating unit comprises:
a focus error signal detecting unit to detect the first and second focus error signals; and
an objective lens driver control signal generator to generate the control signal which applies a defocus corresponding to the average value to a focus servo signal.

31. The multi-channel optical recording and/or reproducing apparatus of claim 28, wherein the control signal generating unit further comprises:
a sum signal detecting unit to detect first and second sum signals corresponding to the first and second light beams; and
a spherical aberration compensating driver control signal generator to generate a second control signal which adjusts a position of a compensating lens to compensate for spherical aberration based on a sum signal for a reference light beam, in which a focus error signal is generated first, among the first and second sum signals.

32. The multi-channel optical recording and/or reproducing apparatus of claim 28, wherein the optical pickup simultaneously emits the first and second light beams to the corresponding tracks.

33. The multi-channel optical recording and/or reproducing apparatus of claim 28, wherein the first and second light sources each comprise a semiconductor laser having one light emitting point or semiconductor laser arrays each having a plurality of light sources.

34. A method of controlling a multi-channel optical recording and/or reproducing apparatus, the method comprising:
emitting first and second light beams to corresponding tracks of an information storage medium and to detect the first and second light beams reflected by the corresponding tracks of the information storage medium; and
generating a control signal based on an average value of first and second focus error signals generated according to the detected first and second light beams, wherein the control signal is used to perform a focusing operation.

35. The method of claim 34, wherein the generating of the control signal comprises generating the average value by averaging a value of a zero crossing point of the first focus error signal and a value of the second focus error signal at a position corresponding to the zero crossing point of the first focus error signal.

36. The method of claim 34, further comprising:
detecting first and second sum signals corresponding to the first and second light beams; and
generating a second control signal which adjusts a position of a compensating lens to compensate for spherical aberration based on a sum signal for a reference light beam, in which a focus error signal is generated first, among the first and second sum signals.

37. The method of claim 34, wherein the emitting of the first and second light beams comprises simultaneously emitting the first and second light beams to the corresponding tracks.
